(19) United States
(12) Patent Application Publication
(10) Pub. No.: US 2026/0320871 A1
(43) Pub. Date: Oct. 15, 2026

(54) INFORMATION PROCESSING APPARATUS, INFORMATION PROCESSING METHOD, AND STORAGE MEDIUM STORING INFORMATION PROCESSING PROGRAM

(71) Applicant: SEIKO EPSON CORPORATION, TOKYO (JP)

(72) Inventors: Kohei YAMAMOTO, MATSUMOTO-SHI (JP); Takashi SERA, SHIOJIRI-SHI (JP); Masayuki KOBAYASHI, FUJIMI-MACHI (JP); Katsuhito KITAHARA, MATSUMOTO-SHI (JP)

(21) Appl. No.: 19/647,968

(22) Filed: Apr. 15, 2026

(30) Foreign Application Priority Data
Apr. 15, 2025 (JP) 2025-066713

(51) Int. Cl. G06T 11/60; H04L 51/10

(52) U.S. Cl. CPC G06T 11/60; H04L 51/10; G06T 2200/24

(57) ABSTRACT

An information processing apparatus that is capable of communicating with a terminal apparatus via a chat server that provides a chat service includes an acquiring section that acquires image data from the terminal apparatus via the chat server, a processing section that processes the acquired image data by adding, to the image data, decorative image data for decorating the image data, and a transmitting section that transmits, to a printing apparatus, an instruction to print the processed image data.

The present application is based on, and claims priority from JP Application Serial Number 2025-066713, filed Apr. 15, 2025, the disclosure of which is hereby incorporated by reference herein in its entirety.

### BACKGROUND

### 1. Technical Field

The present disclosure relates to an information processing apparatus, an information processing method, and a storage medium storing an information processing program.

### 2. Related Art

In the related art, chat services provided on an SNS and the like are known. For example, JP-A-2019-050519 describes an example in which an image is printed by a multifunction peripheral through a dialogue with a chatbot.

It is possible for a user to add a decoration to an image using a terminal apparatus of the user, post the decorated image to a chat room with a chatbot, and print the decorated image using a printing apparatus. However, since it takes time and effort to decorate the image, improvement in convenience has been desired.

### SUMMARY

According to an aspect of the present disclosure, there is provided an information processing apparatus capable of communicating with a terminal apparatus via a chat server that provides a chat service. The information processing apparatus includes an acquiring section that acquires image data from the terminal apparatus via the chat server, a processing section that processes the acquired image data by adding, to the image data, decorative image data for decorating the image data, and a transmitting section that transmits, to a printing apparatus, an instruction to print the processed image data.

According to an aspect of the present disclosure, there is provided an information processing method in an information processing apparatus that includes an acquiring section, a processing section, and a transmitting section and is capable of communicating with a terminal apparatus via a chat server that provides a chat service. The information processing method includes: causing the acquiring section to acquire image data from the terminal apparatus via the chat server; causing the processing section to process the acquired image data by adding, to the image data, decorative image data for decorating the image data; and causing the transmitting section to transmit, to a printing apparatus, an instruction to print the processed image data.

According to an aspect of the present disclosure, there is provided a storage medium storing an information processing program that causes a computer of an information processing apparatus capable of communicating with a terminal apparatus via a chat server that provides a chat service to function as: an acquiring section that acquires image data from the terminal apparatus via the chat server; a processing section that processes the acquired image data by adding, to the image data, decorative image data for decorating the image data; and a transmitting section that transmits, to a printing apparatus, an instruction to print the processed image data.

### BRIEF DESCRIPTION OF THE DRAWINGS

FIG. 1 is a block diagram of a printing system.

FIG. 2 is a diagram illustrating an example of a chat room displayed.

FIG. 3 is a schematic diagram illustrating an example of processing of image data.

FIG. 4 is a diagram illustrating an example of relevant information stored in association with image data.

FIG. 5 is a diagram illustrating an example of decorative image identification information stored in association with a chatbot account.

FIG. 6 is a diagram illustrating an example of print information.

FIG. 7 is a diagram illustrating an example of the chat room displayed.

FIG. 8 is a sequence diagram illustrating a printing sequence.

FIG. 9 is a diagram illustrating an example of the chat room displayed.

FIG. 10 is a sequence diagram illustrating a sequence for acquiring processed image data.

FIG. 11 is a diagram illustrating an example of a list of processed image data displayed.

FIG. 12 is a diagram illustrating an example of resizing and arrangement of image data.

### DESCRIPTION OF EMBODIMENTS

Embodiments of the present disclosure will be described in the following order.
(1) Overall Configuration (1-1) Configuration of Information Processing Apparatus
(2) Sequence
(3) Other Embodiments

### 1 Overall configuration

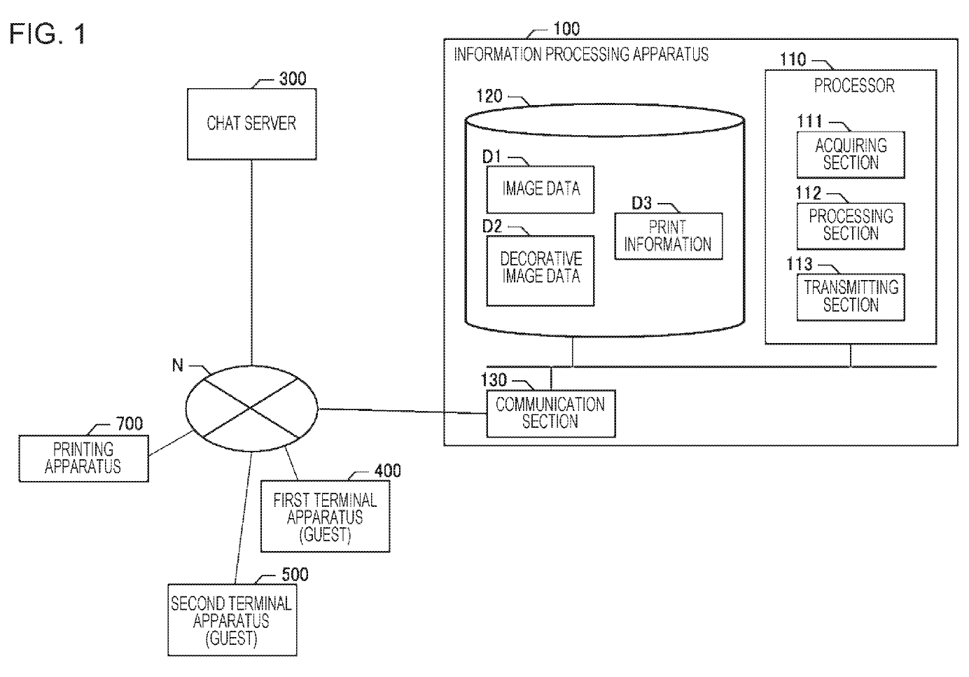

FIG. 1 is a block diagram illustrating an overall configuration of a printing system including an information processing apparatus 100 according to an embodiment of the present disclosure. The information processing apparatus 100 is a server that provides a printing service using a chat service. The information processing apparatus 100 can communicate with a chat server 300 via a network N. The chat server 300 provides the chat service in which a message is exchanged with a partner in a conversation format. A user of the chat service installs, in a terminal apparatus owned by the user, an application (chat application) for using the chat service and creates a user account for the chat service. By executing the chat application, the terminal apparatus communicates with the chat server 300. The information processing apparatus 100 can communicate with the terminal apparatus via the chat server 300.

A first terminal apparatus 400 and a second terminal apparatus 500 have the chat application installed therein. In the present embodiment, it is assumed that the first terminal apparatus 400 and the second terminal apparatus 500 are portable terminals such as smartphones owned by guests invited to a wedding reception following a wedding ceremony. The "wedding reception" in the present embodiment is an example of an event. A printing apparatus 700 is a printer installed in a venue for the wedding reception.

In the present embodiment, for example, a host of the wedding reception creates an account for the chat service in advance. The account is for a chatbot for cooperating with the information processing apparatus 100. When a guest at the wedding reception arrives at the venue, the guest reads, for example, a two-dimensional code set on a table in front of a seat for the guest with a terminal apparatus of the guest, such as a smartphone. The two-dimensional code may be presented in the vicinity of the printing apparatus mounted in the venue. The two-dimensional code includes information for starting the chat application in the terminal apparatus and the account for the chatbot.

When the guest reads the two-dimensional code using the guest's terminal apparatus such as a smartphone, the chat application is started in the terminal apparatus, and selection as to whether to approve the above-described account for the chatbot as a chat partner is requested. When the guest selects approval, the guest can use the printing service using a chat with the chatbot. The printing service using the chat with the chatbot is as follows.

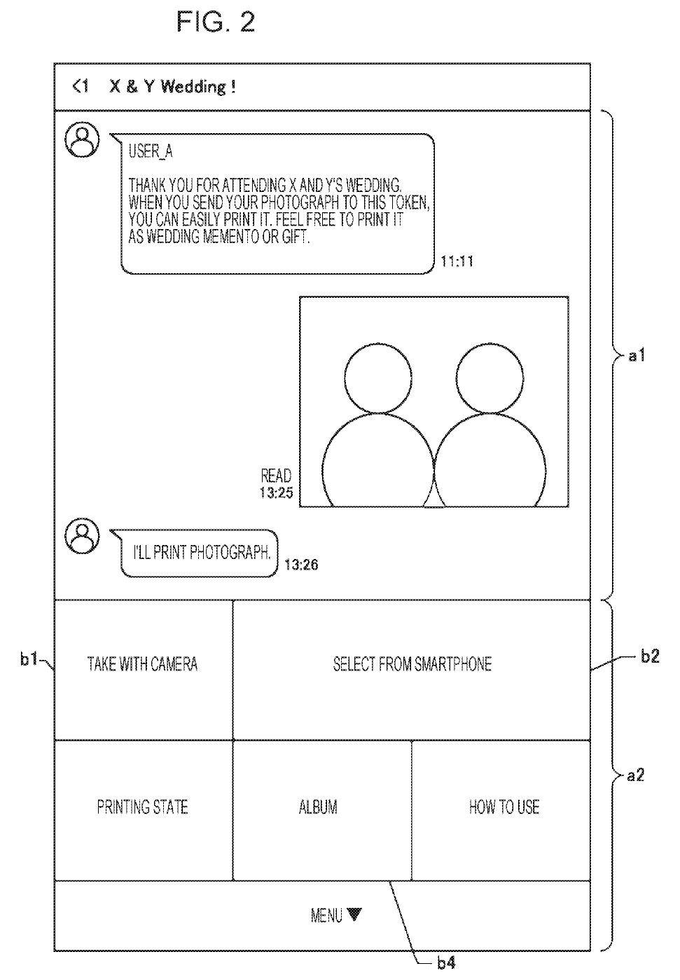

The guest captures, by using a camera on the guest's terminal apparatus, images of scenes at the wedding ceremony and the wedding reception while participating in the wedding ceremony and the wedding reception. The guest posts, in a chat room with the chatbot as illustrated in FIG. 2, a photograph that the guest desires to take home as printed matter among the captured images. The guest can use a service in which the guest sends an image to the chatbot to cause the printing apparatus 700 prepared in the wedding reception venue to print the image and receives the printed photograph.

The chat room is a screen displayed by the chat application, and messages exchanged in a conversational manner and files transmitted and received are displayed in chronological order in the chat room. A chat room in which a chat is exchanged with the chatbot account prepared by the host side of the wedding reception is created for each guest's user account. For example, a chat room between the user of the first terminal apparatus 400 and the chatbot can be viewed in the chat application of the first terminal apparatus 400, and cannot be viewed by the user of the second terminal apparatus 500 in the chat application of the second terminal apparatus 500. On the other hand, a chat room between the user of the second terminal apparatus 500 and the chatbot can be viewed in the chat application of the second terminal apparatus 500, and cannot be viewed by the user of the first terminal apparatus 400 in the chat application of the first terminal apparatus 400.

The printing apparatus 700 is a printer capable of printing a photograph. The printing apparatus 700 communicates with the information processing apparatus 100 and the like via the network N. Upon receiving print data from the information processing apparatus 100, the printing apparatus 700 performs printing on a print medium such as photo paper based on the print data. When the printing apparatus 700 performs the printing, the guest can receive the printed matter printed by the printing apparatus 700 by posting an image to the chat room.

### 1-1 Configuration of Information Processing Apparatus

The information processing apparatus 100 is a server having a print control function of acquiring image data D1 transmitted from the terminal apparatus of the guest via the chat server 300, processing the image data D1 by adding decorative image data D2 to the image data D1, and causing the printing apparatus 700 to perform printing based on the processed image data.

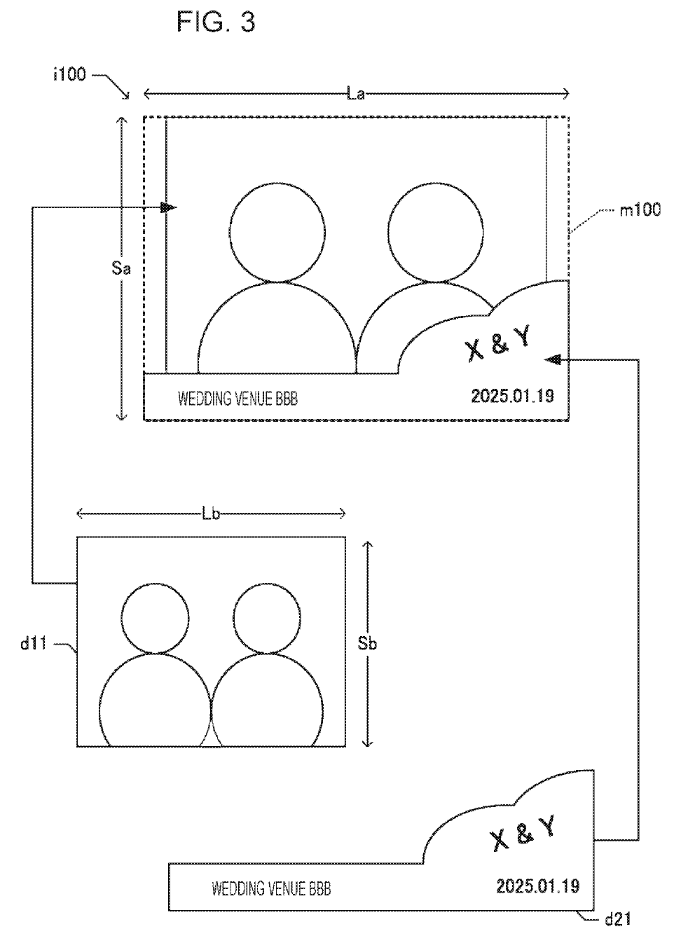

The decorative image data D2 is data for decorating an image posted by the user of the terminal apparatus, and is, for example, data indicating a frame that borders the image, various figures including a stamp and a character to be superimposed on the image, and the like. In the present embodiment, an image indicated by the decorative image data D2 is superimposed on an image indicated by the image data D1 and is printed. In FIG. 3, image data d11 is an example of the image data D1 posted by the user, and decorative image data d21 is an example of the decorative image data D2 stored in advance in a storage medium 120. Image data i100 illustrated in FIG. 3 indicates an image generated by superimposing the decorative image data d21 on the image data d11. The image data obtained by adding the decorative image data D2 to the image data D1 is referred to as processed image data.

The decorative image data D2 includes event information regarding the event associated with the account for the chatbot. For example, the decorative image data includes the name of the event, the date and time of the event, the name of the venue, the name of the host, and the like. In the present embodiment, it may be assumed that the date of the wedding ceremony, the name of the venue, the names of a bride and a groom, and the like are included in the decorative image data. When the decorative image data D2 including the event information is added to the image data D1 for printing, the information processing apparatus 100 can cause the printing apparatus 700 to print the image to which the event information has been added.

The information processing apparatus 100 includes a processor 110, the storage medium 120, and a communication unit 130. The processor 110 includes a CPU, a ROM, a RAM, and the like. Various programs stored in the ROM or the storage medium 120 can be executed by the CPU. The communication section 130 is a communication interface for communicating with the other apparatuses. The information processing apparatus 100 can communicate with the other apparatuses connected to the network N by the communication unit 130. In the storage medium 120, the image data D1 transmitted from the terminal apparatus, that is, the image data D1 posted in the chat room with the chatbot is stored. The decorative image data D2 is stored in advance in the storage medium 120. Further, print information D3 is stored in advance in the storage medium 120.

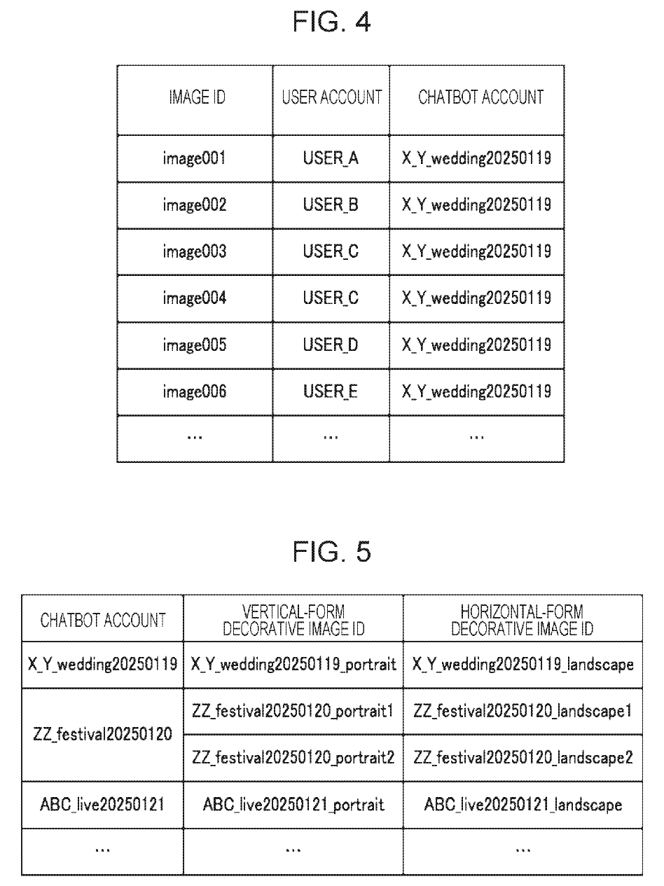

FIG. 4 is a diagram illustrating an example of relevant information stored in the storage medium 120 in association with an image ID of the image data D1. As illustrated in FIG. 4, each piece of image data is associated with an image ID for identifying the piece of image data, and a user account of a user who has posted each piece of image data and the account for the chatbot for the chat room to which the user has posted the piece of image data are stored. Information indicating a posting date and time and an imaging date and time of each piece of image data may be stored in association with an image ID.

FIG. 5 is a diagram illustrating an example of decorative image identification information indicating the decorative image data D2 and stored in the storage medium 120 in association with the chatbot account. As illustrated in FIG. 5, the account for the chatbot in the chat service is stored in the storage medium 120 in association with the decorative image identification information (decorative image ID) indicating the decorative image data corresponding to the chatbot account. An account for the chatbot is created for each event. That is, different chatbot accounts are assigned to events at different dates and venues.

Since images posted by the user may be both vertically oriented and horizontally oriented, vertical-form decorative image data and horizontal-form decorative image data are prepared in advance and stored in the storage medium 120. A vertical-form decorative image ID and a horizontal-form decorative image ID that correspond to the account for the chatbot are stored in the storage medium 120 in association with the account for the chatbot. Note that a vertically-oriented image is an image in which the number of pixels in a height direction of the image is greater than the number of pixels in a width direction of the image, and a horizontally-oriented image is an image in which the number of pixels in the width direction of the image is greater than the number of pixels in the height direction of the image. The height direction of the image is a vertical direction, and the width direction of the image is a horizontal direction.

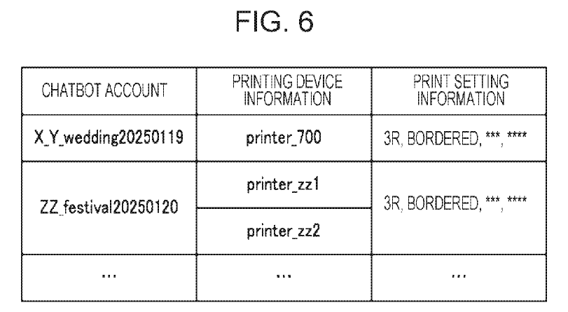

FIG. 6 is a diagram illustrating an example of the print information D3. The print information D3 includes printing device information and print setting information that are associated with the account for the chatbot. The printing device information is information for identifying the printing apparatus that performs printing based on the image posted in the chat room with the chatbot of the corresponding account. For example, the printing device information is identification information of the printer installed in the venue of the event associated with the chatbot account. The print setting information indicates various print parameters in a case where the image posted in the chat room with the chatbot of the corresponding account is printed.

The processor 110 executes a print control program (not illustrated) in order to implement the above-described print control function. By executing the print control program, the processor 110 functions as an acquiring section 111, a processing section 112, and a transmitting section 113.

In the present embodiment, when the user of the terminal apparatus reads a two-dimensional code set on a table in the wedding reception venue and approves the account for the chatbot as a chat partner, the information processing apparatus 100 acquires the user account of the user and the account for the chatbot from the chat server 300. The processor 110 of the information processing apparatus 100 stores the user account and the chatbot account in association with each other. When the user transmits the image data D1 to the chat room with the chatbot, the terminal apparatus of the user transmits the image data D1 to the chat server 300. The processor 110 of the information processing apparatus 100 receives the image data D1 from the chat server 300. That is, the processor 110 of the information processing apparatus 100 acquires the image data D1 from the terminal apparatus via the chat server 300, associates the image data D1 with the ID of the image data D1, and stores the user account of the user who has posted the image data D1 to the chat room and the chatbot account in association with the ID of the image data D1, by using a function of the acquiring section 111. That is, as illustrated in FIG. 4, the processor 110 stores the user account, the chatbot account, and the image data into the storage medium 120 in association with each other.

The processor 110 processes the acquired image data by adding, to the image data, decorative image data for decorating the image data, by using a function of the processing section 112. That is, the processor 110 adds, to the acquired image data, the decorative image data indicated by the decorative image ID corresponding to the chatbot account associated with the image data. More specifically, in a case where the acquired image data is vertically oriented, the processor 110 adds vertical-form decorative image data to the image data. In a case where the acquired image data is horizontally oriented, the processor 110 adds horizontal-form decorative image data to the image data. The processor 110 can acquire the number of pixels of the image data D1 in the width direction and the number of pixels of the image data D1 in the height direction by referring to, for example, a file header of the image data D1, and can determine whether the image data D1 is a vertically-oriented image or a horizontally-oriented image.

Processing by the processing section 112 will be described with reference to FIG. 3. The processor 110 refers to the printing device information and the print setting information in the print information D3 (see FIG. 6) for the chatbot account corresponding to the image data d11, and acquires the size of the print medium to be used for printing by the printing apparatus corresponding to the chatbot account. The processor 110 determines the size of a print region based on the size of the print medium, a setting value indicating borderless printing or bordered printing, the print resolution, and the like. In FIG. 3, reference sign m100 denotes the print region. In the example illustrated in FIG. 3, since the image data d11 is a horizontally-oriented image, a horizontally-oriented print region is virtually set.

The processor 110 resizes the image data while maintaining the aspect ratio of the image data such that the image data is in contact with at least two opposite sides of the print region m100. In this case, as the value of the aspect ratio, a value obtained by dividing the length of a long side of the image data by the length of a short side of the image data will be specifically described. The lengths of long sides of the print region m100 are La, and the lengths of short sides of the print region m100 are Sa. The lengths of long sides of the image data d11 are Lb, and the lengths of short sides of the image data d11 are Sb. In a case where the value of La / Sa is greater than the value of Lb / Sb, the processor 110 enlarges or reduces the image data d11 while maintaining the aspect ratio of the image data d11 such that the two opposite long sides of the image data d11 are in contact with the two opposite long sides of the print region m100, that is, such that the lengths of the short sides of the image data d11 are equal to the lengths of the short sides of the print region m100. In a case where the value of La / Sa is less than the value of Lb / Sb, the processor 110 enlarges or reduces the image data d11 while maintaining the aspect ratio of the image data d11 such that the two opposite short sides of the image data d11 are in contact with the two opposite short sides of the print region m100, that is, such that the lengths of the long sides of the image data d11 are equal to the lengths of the long sides of the print region m100. In a case where the value of La / Sa is equal to the value of Lb / Sb and La ≠ Lb, the processor 110 enlarges or reduces the image data d11 such that the lengths of the long sides of the image data d11 are equal to the lengths of the long sides of the print region m100 and that the lengths of the short sides of the image data d11 are equal to the lengths of the short sides of the print region m100. In a case where both the print region m100 and the image data d11 have a square shape and the length of one of the sides of the print region m100 is different from the length of one of the sides of the image data d11, the image data d11 is resized while maintaining the aspect ratio of the image data d11 such that the four sides of the image data d11 are in contact with the four sides of the print region m100.

The processor 110 arranges the resized image data in the print region m100 and superimposes the decorative image data d21 on the resized image data. That is, in a case where a non-transparent pixel of the decorative image data and a pixel of the image data are positioned on the same pixel of the print region m100, the processor 110 uses a pixel value of the non-transparent pixel of the decorative image data as a pixel value of the pixel of the print region m100. The decorative image data d21 is created in a size corresponding to the size of the print region m100 in advance. The processor 110 transmits an instruction to print the image data i100 generated through the processing described above to the printing apparatus by using a function of the transmitting section 113. That is, the processor 110 converts the image data i100 into print data in a format suitable for printing by the printing apparatus. As illustrated in FIG. 6, the printing apparatus is associated with the chatbot account corresponding to the image data d11. Then, the processor 110 causes the printing apparatus to perform printing based on the print data by transmitting the print data to the printing apparatus.

Since the information processing apparatus 100 is configured as described above, when the user of the terminal apparatus performs an operation of posting image data to the chat room with the chatbot, the image data is transmitted to the information processing apparatus 100 via the chat server 300, and the information processing apparatus 100 can cause the printing apparatus to print the image data to which a decorative image has been automatically added. Therefore, the user may capture an image of a scene of the event by using the camera of the terminal apparatus and transmit the image to the chatbot in the chat application. Since it is not necessary for the user to process the image in the terminal apparatus of the user, the user's convenience can be improved.

Further, since the user does not process the image data D1 by using the decorative image data D2 in the terminal apparatus of the user, the decorative image data D2 is not stored in the terminal apparatus. In some cases, the event host side does not want the decorative image data D2 to be stored in the terminal apparatus of the user. For example, there may be a demand for preventing generation of image data in which decorative image data is added to an image unrelated to an event. According to the present embodiment, the information processing apparatus 100 is configured to add decorative image data, and thus can prevent the decorative image data D2 from being stored in the terminal apparatus of the user.

In addition, since the decorative image data is an image associated with the account for the chatbot to which the user has posted the image data, the user can print the image data to which the decorative image data corresponding to the chatbot has been automatically added. Further, since vertical-form decorative image data is added to vertically-oriented image data and horizontal-form decorative image data is added to horizontally-oriented image data, the user can print image data to which decorative image data corresponding to a form (vertical form or horizontal form) of the image data posted by the user has been automatically added.

In addition, by resizing the image data while maintaining the aspect ratio of the image data such that at least the two opposite sides of the image data are in contact with the two opposite sides of the print region, the processor 110 can automatically adjust the size of the image data without requiring any effort of the user such that the region of the image data in the print region is maximized within a range in which ends of the image data are not outside the print region.

If a printing error occurs in printing of image data in the printing apparatus, the processor 110 associates the account of the user with the account for the chatbot, transmits error information indicating the printing error to the chat server 300, and causes the error information to be displayed in the chat room between the user and the chatbot, by using the function of the transmitting section 113. That is, if the processor 110 transmits print data to the printing apparatus and detects that printing has failed after the transmission of the print data, the processor 110 causes the error information to be displayed in the chat room in the form of a chat in the chat application, by using the function of the transmitting section 113.

More specifically, the processor 110 identifies the user account of the user who has posted the image data corresponding to the print data, and transmits a message including the error information to the terminal apparatus via the chat server 300 for the user account. Upon receiving the message including the error information, the terminal apparatus displays the error information on a display section of the terminal apparatus.

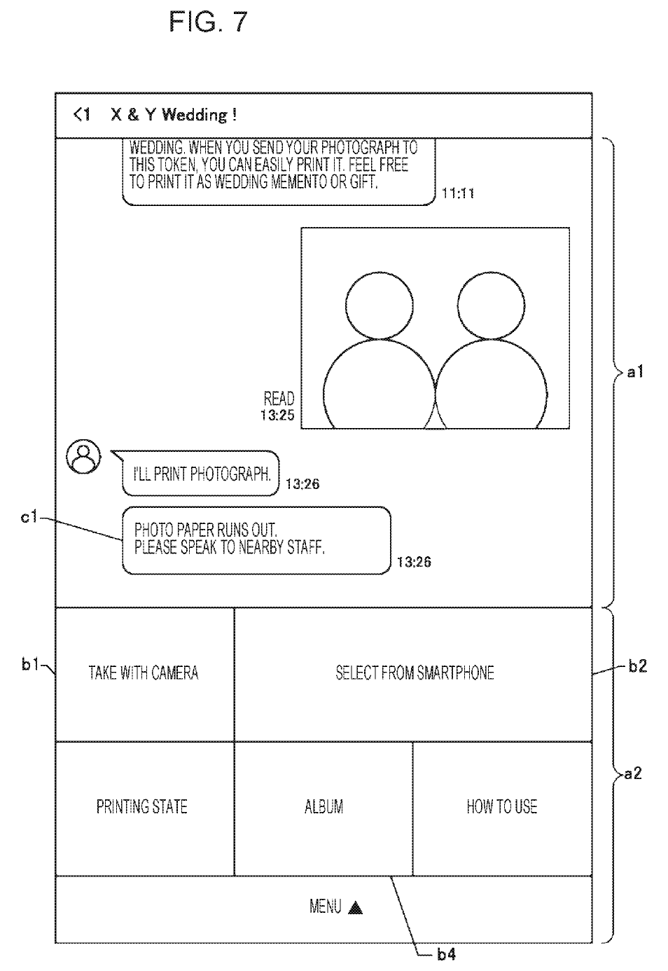

A message c1 illustrated in FIG. 7 indicates an example of the displayed message including the error information. Identification information of the printing apparatus in which the error has occurred may be included in the error information. The printing failure may be caused by various factors that are, for example, running out of print media, running out of ink, and an inability to communicate with the printing apparatus. With this configuration, the user can know, from the message including the error information displayed in the chat room, that the image posted by the user has not been printed due to the printing error. When the printing is successful, a message indicating the success may be displayed in the chat room.

### 2 Sequence

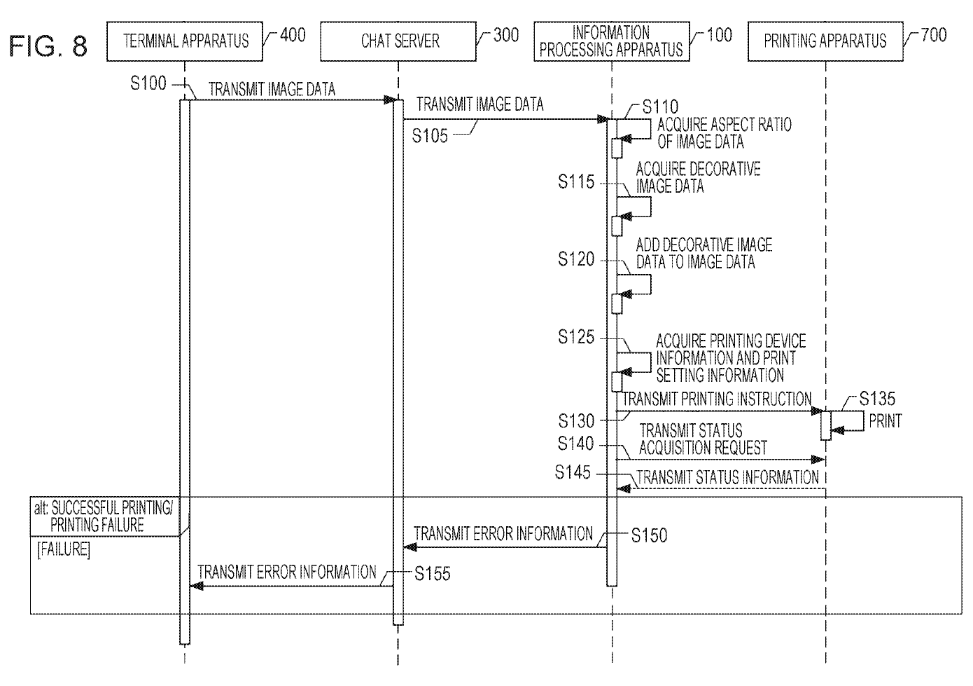

FIG. 8 is a sequence chart illustrating an example of a procedure from posting of an image to printing of the image. In the sequence illustrated in FIG. 8, it is assumed that the guest at the wedding reception reads the two-dimensional code set at the seat for the guest in the wedding reception venue and that the account for the chatbot has been approved. When the user of the terminal apparatus approves the account for the chatbot, the user account of the user of the terminal apparatus for the chat application and the chatbot account are transmitted from the terminal apparatus to the information processing apparatus 100 via the chat server 300. Upon receiving these pieces of information, the processor 110 of the information processing apparatus 100 stores the user account of the user for the chat application and the chatbot account into the storage medium 120 in association with each other.

For example, when the user of the first terminal apparatus 400 starts the chat application and opens the chat room with the chatbot, as illustrated in FIG. 2, a chat section a1 in which a message exchanged with the chatbot is displayed and a menu section a2 are displayed. The menu section a2 includes a button b1 for starting the camera, a button b2 for selecting an image already captured by the terminal apparatus, a button b4 for viewing an album, and the like. In the chat room, only one chatbot account and the account of the user of the terminal apparatus are registered. Another guest who participates in the wedding ceremony and the wedding reception also approves the same chatbot as a chat partner. However, in the chat application of the other guest, only the account for the chatbot and an account of the other guest are registered in the chat room with the chatbot. In this way, only the chatbot and the account of the user as a participant in the chat room are displayed in the chat room, and another user who registers the same chatbot is not displayed as a participant in the chat room in which the user participates.

The user can capture images of scenes of the wedding ceremony, the wedding reception, and the venue using the camera started by selecting the button b1, and post the captured images to the chat room. The user can select an image to be printed from a displayed list of images already captured and stored in the terminal apparatus of the user by selecting the button b2, and post the image to the chat room.

When the user performs an operation of posting an image to be printed to the chat room by any one of the above-described methods, the first terminal apparatus 400 transmits image data D1 indicating the image to the chat server 300 (step S100). Upon receiving the image data D1, the chat server 300 transmits the image data to the information processing apparatus 100 (step S105). Specifically, the chat server 300 notifies the information processing apparatus 100 that the image has been posted, and the information processing apparatus 100 receives the notification and transmits an image acquisition request to the chat server 300. In response to the image acquisition request, the chat server 300 transmits the image data D1 to the information processing apparatus 100. Specifically, the chat server 300 transmits the image data D1, the user account of the user who has posted the image, and the account for the chatbot to the information processing apparatus 100. The processor 110 acquires these pieces of information by using the function of the acquiring section 111 and stores the image data D1 into the storage medium 120. In addition, the processor 110 stores the user account of the user who has posted the image data D1 and the account for the chatbot into the storage medium 120 in association with the image data D1 as illustrated in FIG. 4.

Subsequently, the processor 110 acquires the aspect ratio of the image data D1 by using the function of the processing section 112 (step S110). For example, the processor 110 refers to the file header of the image data D1 and acquires the height and width of the image. The processor 110 identifies whether the image data D1 is a vertically-oriented image or a horizontally-oriented image based on the height of the image, that is, the length in the vertical direction, and the width, that is, the length in the horizontal direction.

The processor 110 acquires decorative image data D2 by using the function of the processing section 112 (step S115). That is, the processor 110 refers to the association between the image data and the chatbot account as illustrated in FIG. 4, and identifies the chatbot account associated with the image data D1. The processor 110 acquires the decorative image data that matches the vertically-oriented or horizontally-oriented image identified in step S110 from among decorative image data stored in the storage medium 120 in association with the chatbot account. That is, the processor 110 refers to the association between the chatbot account and the decorative image data as illustrated in FIG. 5, and identifies the decorative image data associated with the chatbot account. If the processor 110 determines in step S115 that the image data D1 is vertically oriented, vertical-form decorative image data is acquired in step S115. If the processor 110 determines in step S115 that the image data D1 is horizontally oriented, horizontal-form decorative image data is acquired in step S115.

Subsequently, the processor 110 adds the decorative image data D2 to the image data D1 by using the function of the processing section 112 (step S120). That is, as illustrated in FIG. 3, the processor 110 sets the print region m100, resizes the image data so as to cause the two opposite sides of the image to be in contact with the two opposite sides of the print region m100, and superimposes the decorative image data on the resized image data to generate processed image data.

Subsequently, the processor 110 acquires the printing device information and the print setting information by using the function of the transmitting section 113 (step S125). That is, the processor 110 refers to the print information D3 and acquires the printing device information and the print setting information stored in association with the chatbot account.

Subsequently, the processor 110 transmits an instruction to print the processed image data, by using the function of the transmitting section 113 (step S130). That is, the processor 110 generates print data for causing the printing apparatus indicated by the printing device information to print the processed image data according to a print setting indicated by the print setting information, and transmits the print data to the printing apparatus indicated by the printing device information. In a case where the printing apparatus indicated by the printing device information is the printing apparatus 700, the processor 110 transmits the print data to the printing apparatus 700. Upon receiving the print data, the printing apparatus 700 performs printing based on the print data (step S135).

Subsequently, the processor 110 transmits a status acquisition request to the printing apparatus 700 (step S140),

and acquires status information transmitted from the printing apparatus 700 (step S145). In a case where the status information acquired in step S145 includes error information indicating that the printing has failed in the printing apparatus 700, the processor 110 transmits the error information to the chat server 300 by using the function of the transmitting section 113 (step S150). That is, the processor 110 identifies the user account of the user who has posted the image data corresponding to the print data transmitted in step S130, and transmits a message including the error information for the chat application to the chat server 300 for the user account. Next, the chat server 300 transmits the error information to the terminal apparatus indicated by the user account (step S155). That is, the message including the error information is transmitted from the chat server 300 to the terminal apparatus. Upon receiving the message including the error information, the terminal apparatus displays the message on the display section of the terminal apparatus.

When the printing is successful, a message indicating the success is not displayed in the present embodiment, but the message indicating the success may be displayed in the chat room.

### 3 Other Embodiments

The above-described embodiment is merely an example of implementing the present disclosure, and various other embodiments may also be adopted. For example, the information processing apparatus may include a plurality of servers. The assignment of processing of each of the servers may be designed as appropriate. For example, the processing of processing the image data may be performed by a first server, and the processing of printing the processed image data by the printing apparatus may be executed by a second server.

The printing system can be used for various events in addition to the wedding ceremony, the wedding reception, and the like described above in the embodiment. For example, the printing system can be used in venues for concerts, live performances, parties, dinner shows, local festivals, municipal events, events for children, and the like.

In the above-described embodiment, only one printing apparatus is illustrated. However, a plurality of printing apparatuses may be installed in the venue and registered in a state where the plurality of printing apparatuses can cooperate with the information processing apparatus 100. For example, the information processing apparatus 100 may be configured to switch an output destination to another standby printer and cause the standby printer to perform printing in a state where the printing apparatus used as the main printing apparatus cannot perform printing due to an error. Alternatively, in order to improve the efficiency of printing, the plurality of printing apparatuses may be operated.

The processing section may be capable of processing the acquired image data by adding, to the image data, decorative image data for decorating the image data. In the above-described embodiment, the decorative image data is superimposed on the image data, but the present disclosure is not limited to superimposing the decorative image data on the image data. For example, superimposing decorative image data beneath the image data may be included as an example of the processing by the processing section. Further, for example, arranging the decorative image data outside the image data without overlapping the image data and the decorative image data may be included as an example of the processing by the processing section. When the decorative image data is superimposed on the image data, the decorative image data may make the image data completely opaque as in the above-described embodiment, but the transmittance of the decorative image data may be greater than 0% and less than 100%.

The processing section may be configured to display, in the chat room between the user of the terminal apparatus and the chatbot, an option to select whether to add the decorative image data, and to display, in the chat room, a result of the selection by the user. Further, the processing section may be configured to display an option to select the decorative image data in the chat room between the user of the terminal apparatus and the chatbot, and to display, in the chat room, a result of the selection by the user.

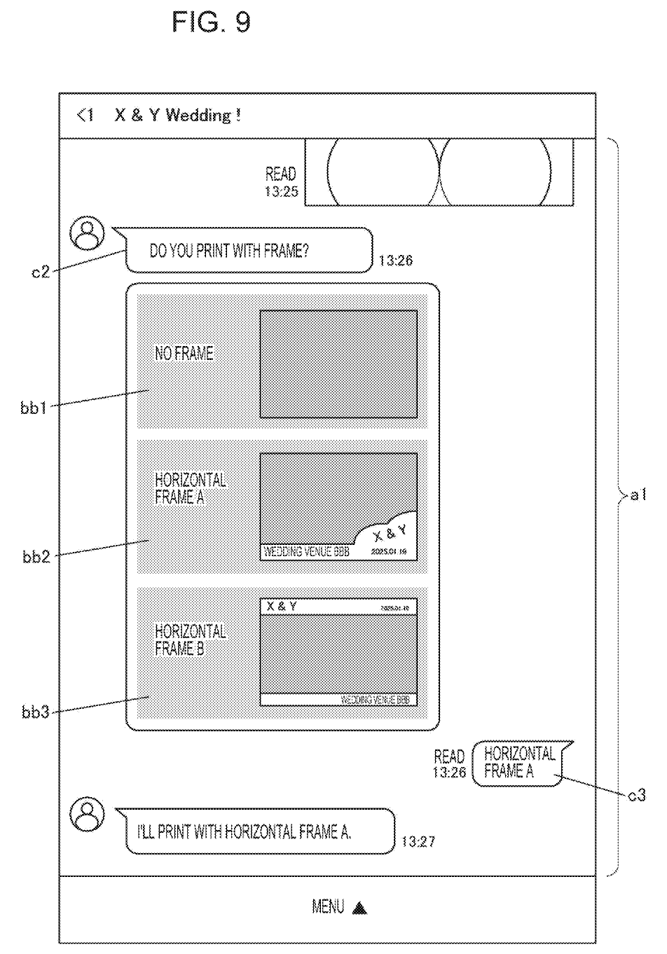

FIG. 9 illustrates an example of the chat room after the user posts the image to the chat room with the chatbot. After performing step S115 illustrated in FIG. 8, the processor 110 of the information processing apparatus 100 transmits, to the chat server 300, a message c2 for asking whether to add decorative image data, and an instruction to post options bb1, bb2, and bb3 to the chat room with the user. The options bb1, bb2, and bb3 are buttons for the user to select whether to add decorative image data, and to select which decorative image data to add in a case where the decorative image data is to be added. As a result, as illustrated in FIG. 9, the message c2 and the options bb1, bb2, and bb3 are displayed in the chat room with the chatbot in the terminal apparatus of the user.

When the user taps any one of the options, the terminal apparatus displays a message c3 indicating a selection result by the user in the chat section a1. In the example illustrated in FIG. 9, the message c3 indicating that printing with decorative image data "horizontal frame B" added has been selected is displayed. If the option bb1 indicating that decorative image data is not added is selected, a message indicating that decorative image data is not added is displayed as a selection result.

The selection result may be displayed in the form of a character as illustrated in FIG. 9 or may be displayed in the form of a print preview image. The print preview image displayed as the selection result is a thumbnail image obtained by reducing the image in a state where the decorative image data is superimposed on the image data, as indicated by i100 in FIG. 3, for example, in a case where the addition of the decorative image data is selected. Note that the options bb1, bb2, and bb3 may be displayed in a state where a print preview image when each option is selected is included in advance. A selection result in this case may be in the form of a character as illustrated in FIG. 9 or in the form of a print preview image.

With the configuration, it is possible to leave, as a history in the chat room, whether the user has selected to add a decorative image and perform printing. Further, the decorative image selected by the user can be left in the chat room as a history. In the example illustrated in FIG. 9, whether to add decorative image data and the type of decorative image data are selected in one step, but may be separately selected in two steps.

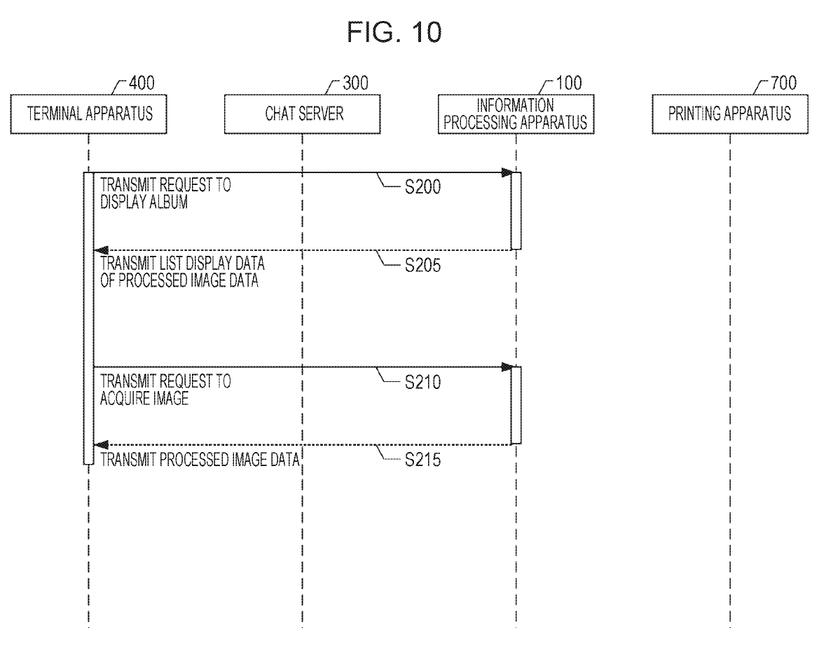

The processing section may be configured to store the processed image data into the storage medium, and transmit the image data to the terminal apparatus in response to an acquisition request from a user of the terminal apparatus. When the user posts image data from the terminal apparatus, the processor 110 processes the image data by adding decorative image data to the image data, and stores the processed image data into the storage medium 120 in association with the account for the chatbot. That is, after the execution of step S120 illustrated in FIG. 8, the processed image data is stored in the storage medium 120. Both the image data before the processing and the image data after the processing may be stored. For example, when the user taps the button b4 (see FIG. 2) in the chat room with the chatbot account in the terminal apparatus of the user, as illustrated in FIG. 10, the terminal apparatus transmits a request to display an album to the information processing apparatus 100 together with the chatbot account registered in the chat room and the account of the user (step S200). In response to the request to display the album, the processor 110 of the information processing apparatus 100 returns, to the terminal apparatus, list display data of processed image data stored in association with the chatbot account (step S205).

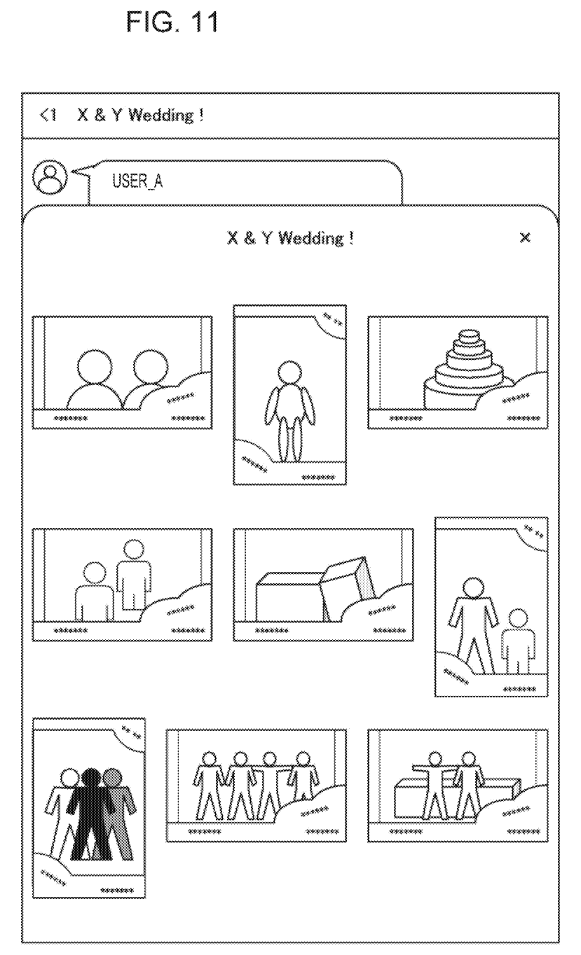

FIG. 11 illustrates an example of a list displayed on the terminal apparatus based on the list display data. The displayed list may include not only image data posted by the user of the terminal apparatus that has transmitted the request to display the album in step S200 but also image data stored in association with the chatbot account and posted by another user. That is, the user can also view an image posted to the chat room with the chatbot account by the other user who participates in the same event. When the user of the terminal apparatus selects, from the list, an image to be downloaded, the terminal apparatus transmits, to the information processing apparatus 100, a request to acquire the selected image, that is, processed image data (step S210). The processor 110 of the information processing apparatus 100 transmits the requested image, that is, the processed image data, to the terminal apparatus (step S215). With this configuration, the user of the terminal apparatus can download the processed image data to the terminal apparatus. The image processing apparatus may be configured to be capable of downloading unprocessed image data. The image processing apparatus may be configured to enable the user to select whether to download the image data before processing or the processed image data, and may be configured to enable the host side of the event to determine in advance whether to allow the image data before processing or the processed image data to be downloaded.

The processing section may be configured to acquire decorative image data created by the user of the terminal apparatus, and to process the acquired image data by adding the decorative image data created by the user of the terminal apparatus to the image data. In the above-described embodiment, the decorative image data is created in advance by the host or a person on the host side such as venue staff and stored in the storage medium 120 of the information processing apparatus 100. However, the decorative image data may be created by the user of the terminal apparatus and stored in the storage medium 120 of the information processing apparatus 100. For example, the user creates favorite decorative image data by using a server that supports creation of a decorative image to be superimposed on a photo image, and registers the decorative image data in the information processing apparatus 100. The terminal apparatus of the user is configured to be capable of processing the image data by adding the registered decorative image data to the image data. Therefore, the user can cause the printing apparatus to print an image to which any decorative image has been added. For example, the decorative image data may be created by the user combining a plurality of decorative image portions or frames prepared by the host side in any manner, or may be newly created by the user.

The decorative image data may be registered, for example, as follows. The menu section a2 illustrated in FIG. 2 includes a button for accepting the registration of decorative image data. When the user taps the button, a site of a server that supports creation of a decorative image is displayed on the terminal apparatus. When the user creates decorative image data and performs a registration operation on the site, the created decorative image data is transmitted to the information processing apparatus 100 together with the chatbot account. The information processing apparatus 100 stores the decorative image data in association with the chatbot account. For example, as illustrated in FIG. 9, the user can select decorative image data created by the user from among decorative image data stored in association with the chatbot account, add the decorative image data created by the user to the image data posted by the user, and cause the printing apparatus to print the image data with the decorative image data added thereto.

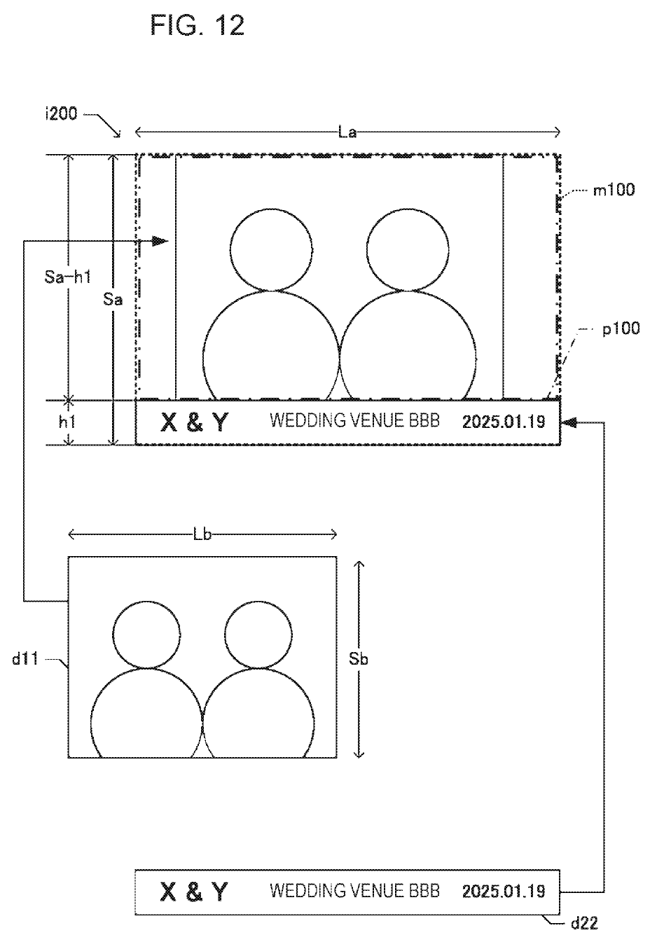

The processing section may be configured to change the arrangement and resizing of the image data with respect to the print region m100 according to an arrangement pattern of a decorative image. That is, the position and size of the image data in the print region m100 may be changed such that the portion where the image data is occupied and hidden by the decorative image is reduced in size. For example, as in image data i200 illustrated in FIG. 12, in a case where decorative image data d22 is positioned at a bottom portion of the print region m100, the image data d11 may be resized such that the image data d11 is positioned within a region p100 that has a height Sa-h1 and a width La and that is in contact with an upper side of the print region m100. More specifically, for example, the image data d11 may be resized and arranged in the region p100 such that two opposite sides of the image data d11 are in contact with two opposite sides of the region p100.

Further, the present disclosure can also be applied as an information processing program and an information processing method that are executed by a computer. Further, the system, the program, and the method as described above may be implemented as a single apparatus or may be implemented by using components included in a plurality of apparatuses, and include various aspects. The configuration described above may also be modified as appropriate such that the configuration is implemented by a combination of software and hardware. Further, the present disclosure is also established as a storage medium for storing the program that controls the system. It is needless to say that the storage medium for storing the program may be a magnetic storage medium or a semiconductor memory, and any storage medium that will be developed in the future can be considered in exactly the same way.

What is claimed is:

1. An information processing apparatus capable of communicating with a terminal apparatus via a chat server that provides a chat service, the information processing apparatus comprising:
an acquiring section that acquires image data from the terminal apparatus via the chat server;
a processing section that processes the acquired image data by adding, to the image data, decorative image data for decorating the image data; and
a transmitting section that transmits, to a printing apparatus, an instruction to print the processed image data.

2. The information processing apparatus according to claim 1, further comprising
a storage medium that stores an account for a chatbot in the chat service and decorative image identification information indicating the decorative image data in association with each other, wherein
the acquiring section acquires the image data associated with the account for the chatbot, and
the processing section adds, to the acquired image data, the decorative image data indicated by the decorative image identification information corresponding to the account for the chatbot associated with the image data.

3. The information processing apparatus according to claim 2, wherein
the storage medium stores vertical-form decorative image data and horizontal-form decorative image data, and
the processing section adds the vertical-form decorative image data to the image data in a case where the acquired image data is vertically oriented, and adds the horizontal-form decorative image data to the image data in a case where the acquired image data is horizontally oriented.

4. The information processing apparatus according to claim 1, wherein
the processing section resizes the image data while maintaining an aspect ratio of the image data so as to cause the image data to be in contact with at least two opposite sides of a print region of a print medium to be used by the printing apparatus to print the image data.

5. The information processing apparatus according to claim 1, wherein
the decorative image data includes event information regarding an event corresponding to an account for a chatbot in the chat service.

6. The information processing apparatus according to claim 1, wherein
the processing section displays, in a chat room between a user of the terminal apparatus and a chatbot, an option to select whether to add the decorative image data, and displays, in the chat room, a result of the selection by the user.

7. The information processing apparatus according to claim 1, wherein
the processing section displays an option to select the decorative image data in a chat room between a user of the terminal apparatus and a chatbot, and displays, in the chat room, a result of the selection by the user.

8. The information processing apparatus according to claim 1, wherein
the acquiring section acquires the image data in which an account of a user of the terminal apparatus in the chat service is associated with an account for a chatbot in the chat service, and
if a printing error occurs in the printing of the image data in the printing apparatus, the transmitting section associates the account of the user with the account for the chatbot, transmits error information indicating the printing error to the chat server, and causes the error information to be displayed in a chat room between the user and the chatbot.

9. The information processing apparatus according to claim 1, wherein
the processing section stores the processed image data into a storage medium and transmits the image data to the terminal apparatus in response to an acquisition request from a user of the terminal apparatus.

10. The information processing apparatus according to claim 1, wherein
the processing section
acquires the decorative image data created by a user of the terminal apparatus, and
processes the acquired image data by adding the decorative image data created by the user of the terminal apparatus to the image data.

11. An information processing method in an information processing apparatus that includes an acquiring section, a processing section, and a transmitting section and is capable of communicating with a terminal apparatus via a chat server that provides a chat service, the information processing method comprising:
causing the acquiring section to acquire image data from the terminal apparatus via the chat server;
causing the processing section to process the acquired image data by adding, to the image data, decorative image data for decorating the image data; and
causing the transmitting section to transmit, to a printing apparatus, an instruction to print the processed image data.

12. A storage medium storing an information processing program that causes a computer of an information processing apparatus capable of communicating with a terminal apparatus via a chat server that provides a chat service to function as:
an acquiring section that acquires image data from the terminal apparatus via the chat server;
a processing section that processes the acquired image data by adding, to the image data, decorative image data for decorating the image data; and
a transmitting section that transmits, to a printing apparatus, an instruction to print the processed image data.
